(19) United States
(12) Patent Application Publication
(10) Pub. No.: US 2016/0225556 A1
(43) Pub. Date: Aug. 4, 2016

(54) DISPLAY DEVICE AND BUTTON MODULE THEREOF

(71) Applicant: Wistron Corporation, New Taipei City (TW)

(72) Inventors: YAN PING WU, New Taipei City (TW); JITAO LI, New Taipei City (TW); SHAO BO PENG, New Taipei City (TW); WEI XU, New Taipei City (TW)

(21) Appl. No.: 14/705,999

(22) Filed: May 7, 2015

(30) Foreign Application Priority Data
Jan. 29, 2015 (CN) 201510046758.3

(51) Int. Cl. H01H 19/14; H01H 15/06

(52) U.S. Cl. CPC H01H 19/14; H01H 15/06; H01H 2217/00

(57) ABSTRACT

A display device includes a casing, a device body, and a button module. The device body is disposed in the casing. The button module is disposed on the casing. The button module includes a button circuit board and a triggering member. The button circuit board is electrically connected to the device body. The triggering member is movably or rotatably disposed at a side of the button circuit board for moving or rotating to trigger the button circuit board so as to control the device body to execute a corresponding function.

### BACKGROUND OF THE INVENTION

1. Field of the Invention

The present invention relates to a display device and a button module thereof, and more specifically, to a display device utilizing a triggering member to move or rotate to trigger a button circuit board for executing a corresponding function and a button module thereof.

2. Description of the Prior Art

In general, a display device (e.g. a computer monitor) usually has function buttons disposed thereon, so that a user could press one of the function buttons to control the display device to execute a corresponding function. A common button design is to dispose a button structure with a plurality of buttons formed thereon on an outer frame of the display device and then dispose a button circuit board with a plurality of switches in the outer frame corresponding to the button structure. Accordingly, the user could press one of the buttons on the button structure to trigger the corresponding switch on the button circuit board, so as to control the display device to execute a corresponding function, such as turning on/off the display device or performing brightness adjustment of the display device.

However, since the plurality of buttons on the button structure usually needs to be manufactured by a specific mold, the aforesaid design could cause a time-consuming and strenuous button manufacturing process. Furthermore, since the button circuit board needs to be fixed to the outer frame in a screw locking manner, the aforesaid design could also result in a complicated button assembly process.

### SUMMARY OF THE INVENTION

The present invention provides a display device including a casing, a device body, and a button module. The device body is disposed in the casing. The button module is disposed on the casing. The button module includes a button circuit board and a triggering member. The button circuit board is electrically connected to the device body. The triggering member is movably or rotatably disposed at a side of the button circuit board for moving or rotating to trigger the button circuit board so as to control the device body to execute a corresponding function.

The present invention further provides a button module disposed on a casing of a display device. The button module includes a button circuit board and a triggering member. The button circuit board is electrically connected to the display device. The triggering member is movably or rotatably disposed at a side of the button circuit board for moving or rotating to trigger the button circuit board so as to control the display device to execute a corresponding function.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a display device according to a first embodiment of the present invention.

FIG. 2 is an exploded diagram of a button module in FIG. 1.

FIG. 3 is a diagram of a button circuit board in FIG. 2 being fixed to a casing.

FIG. 4 is a diagram of a triggering member in FIG. 1 sliding along a sliding slot to a position corresponding to a mark M.

FIG. 5 is a diagram of a display device according to a second embodiment of the present invention.

FIG. 6 is an exploded diagram of a button module and the casing in FIG. 5.

FIG. 7 is a diagram of a display device according to a third embodiment of the present invention.

FIG. 8 is a partial diagram of a casing in FIG. 7.

FIG. 9 is a diagram of a button module in FIG. 7.

FIG. 10 is a partial internal diagram of the display device in FIG. 7.

FIG. 11 is a diagram of a display device according to a fourth embodiment of the present invention.

FIG. 12 is a diagram of a button module in FIG. 11.

FIG. 13 is a diagram of a display device according to a fifth embodiment of the present invention.

FIG. 14 is an exploded diagram of a button module in FIG. 13.

FIG. 15 is a diagram of a U-shaped button in FIG. 14 at another viewing angle.

### DETAILED DESCRIPTION

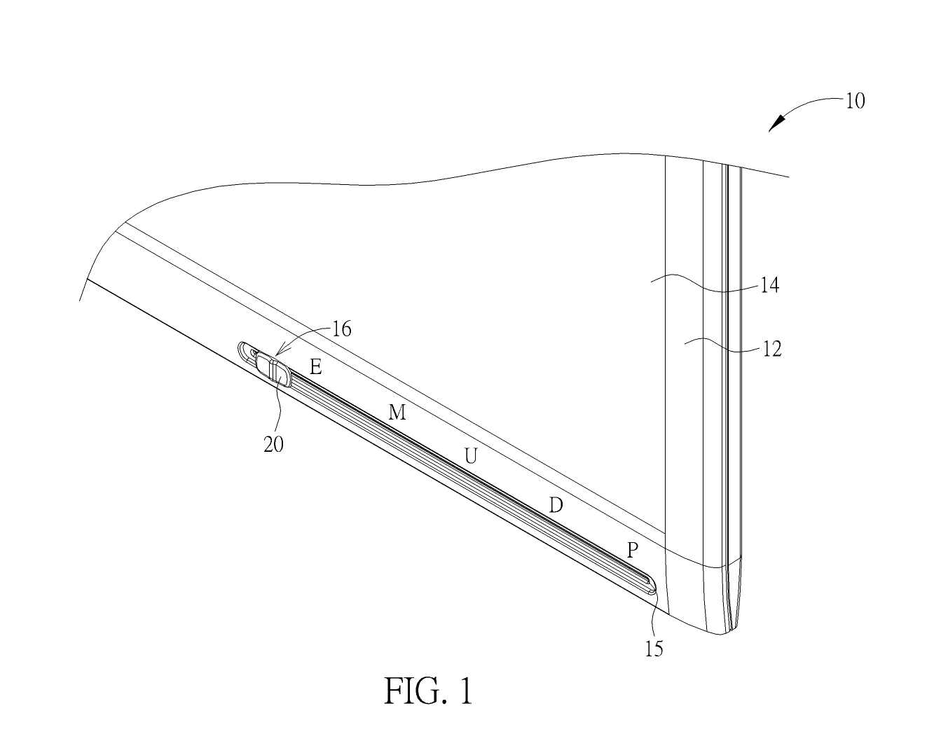

Please refer to FIG. 1, which is a diagram of a display device 10 according to a first embodiment of the present invention. As shown in FIG. 1, the display device 10 could be a conventional display apparatus (e.g. a computer monitor) and includes a casing 12, a device body 14, and a button module 16. The casing 12 could adopt the structural design commonly applied to an outer frame of a conventional display apparatus, such as an assembly design of a front frame and a back cover. The device body 14 is disposed in the casing 12. The device body 14 could include main components in a conventional display apparatus, such as a main board and a monitor panel, and the related description for the main components is omitted herein since it is commonly seen in the prior art.

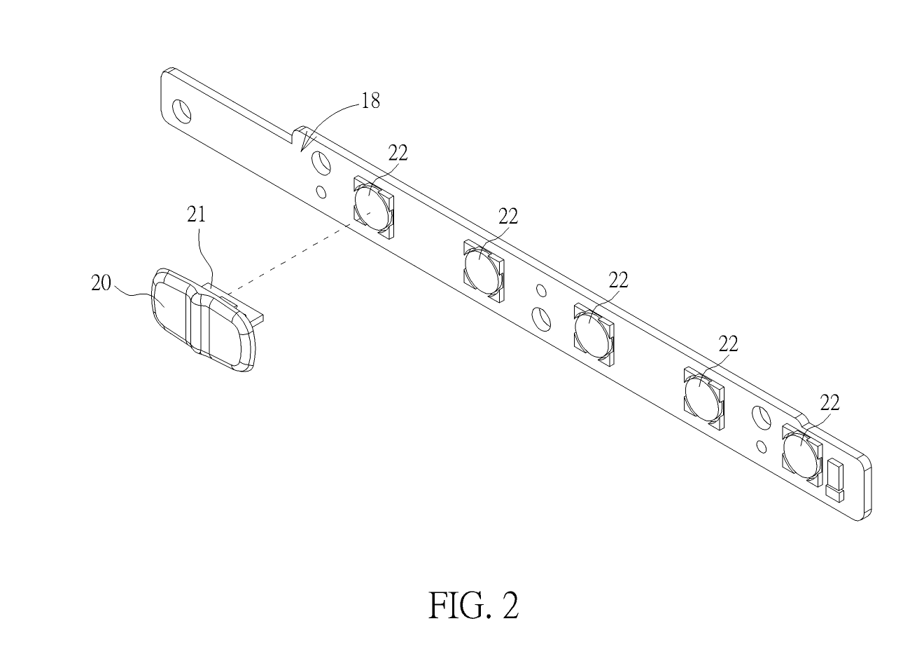

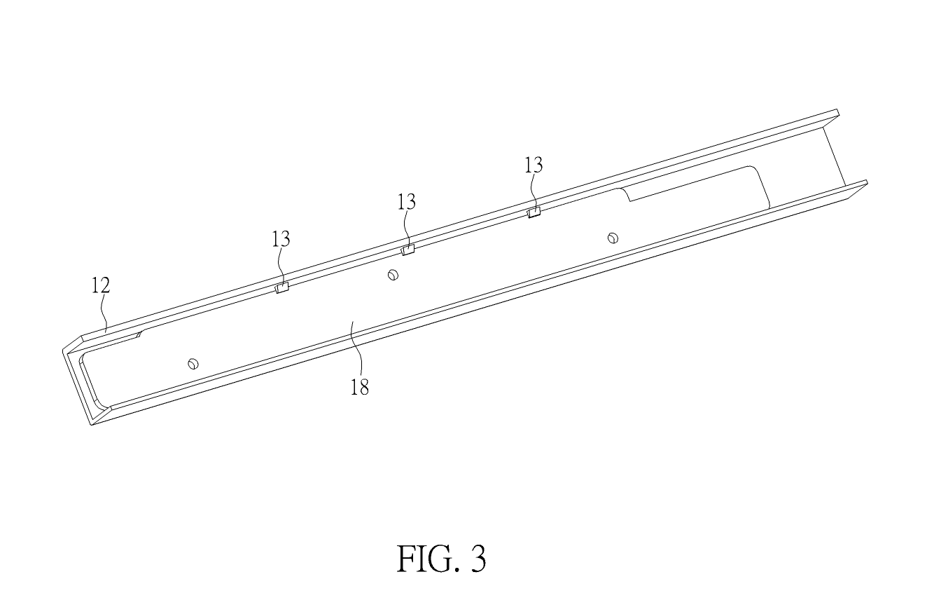

More detailed description for the design of the button module 16 is provided as follows. Please refer to FIG. 1 and FIG. 2. FIG. 2 is an exploded diagram of the button module 16 in FIG. 1. As shown in FIG. 1 and FIG. 2, the button module 16 is disposed on the casing 12 for a user to perform a button sliding operation of the display device 10. The button module 16 includes a button circuit board 18 and a triggering member 20. The button circuit board 18 is electrically connected to the device body 14 and has a plurality of switches 22. Accordingly, the button module 16 could control the device body 14 to execute a corresponding function (e.g. turning on/off the display device 10 or opening a function menu of the display device 10) when one of the switches 22 is pressed by the user. As for the fixing design of the button circuit board 18 and the casing 12, it could be as shown in FIG. 3, which is a diagram of the button circuit board 18 in FIG. 2 being fixed to the casing 12. The casing 12 is depicted partially in FIG. 3 for clearly showing the fixing design of the button circuit board 18 and the casing 12. As shown in FIG. 3, in this embodiment, the casing 12 could have at least one hook structure 13 (three shown in FIG. 3, but not limited thereto). The hook structure 13 is engaged with the button circuit board 18 for fixing the button circuit board 18 on the casing 12.

As shown in FIG. 1 and FIG. 2, the triggering member 20 could be a sliding button and could have a protruding structure 21 formed toward the button circuit board 18 for triggering the switch 22, but not limited thereto, meaning that the triggering member 20 could adopt other triggering structural design. A sliding slot 15 is formed on the casing 12. The triggering member 20 is movably inserted into the sliding slot 15, so that the user could push the triggering member 15 to slide along the sliding slot 15 for triggering the switch 22 on the button circuit board 18.

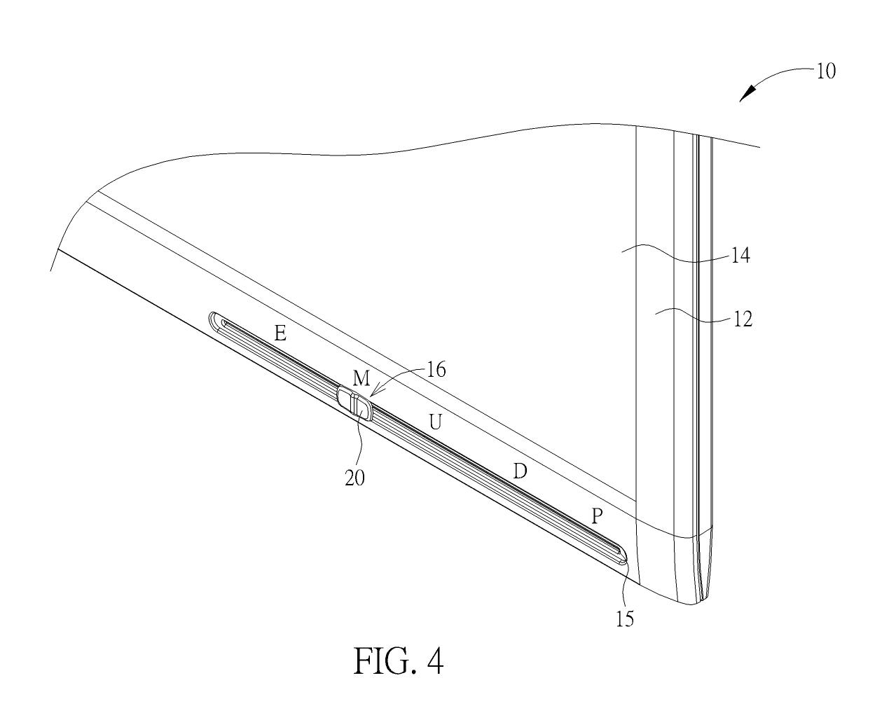

For example, please refer to FIG. 1, FIG. 2, and FIG. 4. FIG. 4 is a diagram of the triggering member 20 in FIG. 1 sliding along the sliding slot 15 to a position corresponding to a mark M. When the user wants to open a function menu of the display device 10 (i.e. a function corresponding to the mark M), the user just needs to push the triggering member 20 along the sliding slot 15 from a position as shown in FIG. 1 to a position as shown in FIG. 4, and then presses the triggering member 20. At this time, since the triggering member 20 is aligned with the switch 22 corresponding to the mark M on the button circuit board 18, the protruding structure 21 of the triggering member 20 could trigger the switch 22 corresponding to the mark M when the user presses the triggering member 20. Accordingly, the device body 14 could be controlled to execute the function corresponding to the mark M (i.e. opening the function menu), so that the user could perform the subsequent operations of the display device 10 (e.g. brightness adjustment of the display device 10). In such a manner, via the aforesaid design that the switch 22 on the button circuit board 18 could be triggered by only one triggering member 20, the present invention could efficiently solve the prior art problem that the button manufacturing process is time-consuming and strenuous. Furthermore, since the present invention adopts the aforesaid structural engagement design to replace a screw locking design for fixing the button circuit board 18 on the casing 12, the present invention could also simplify the button assembly process of the display device 10.

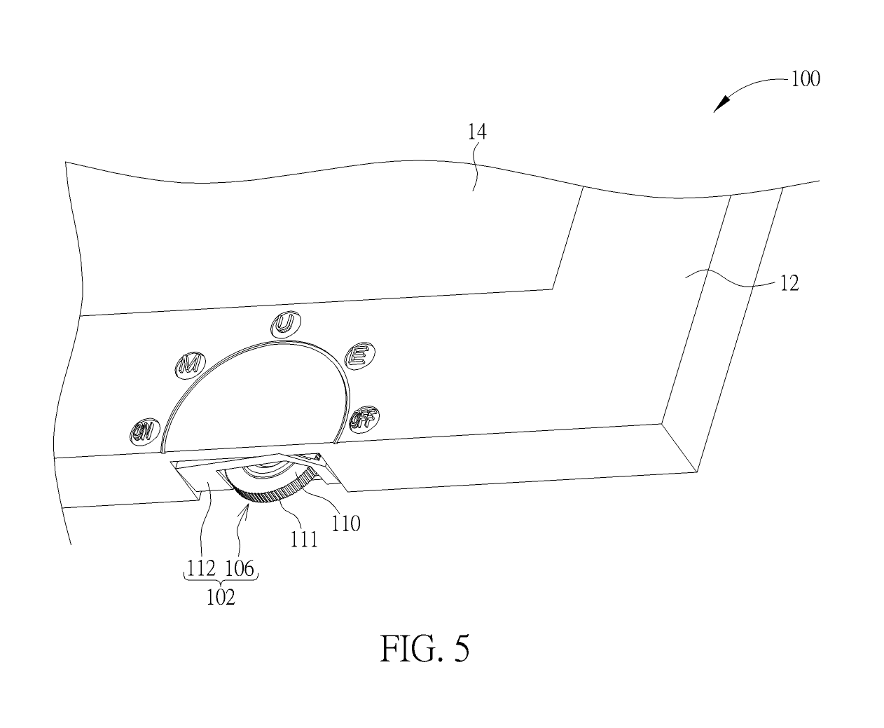

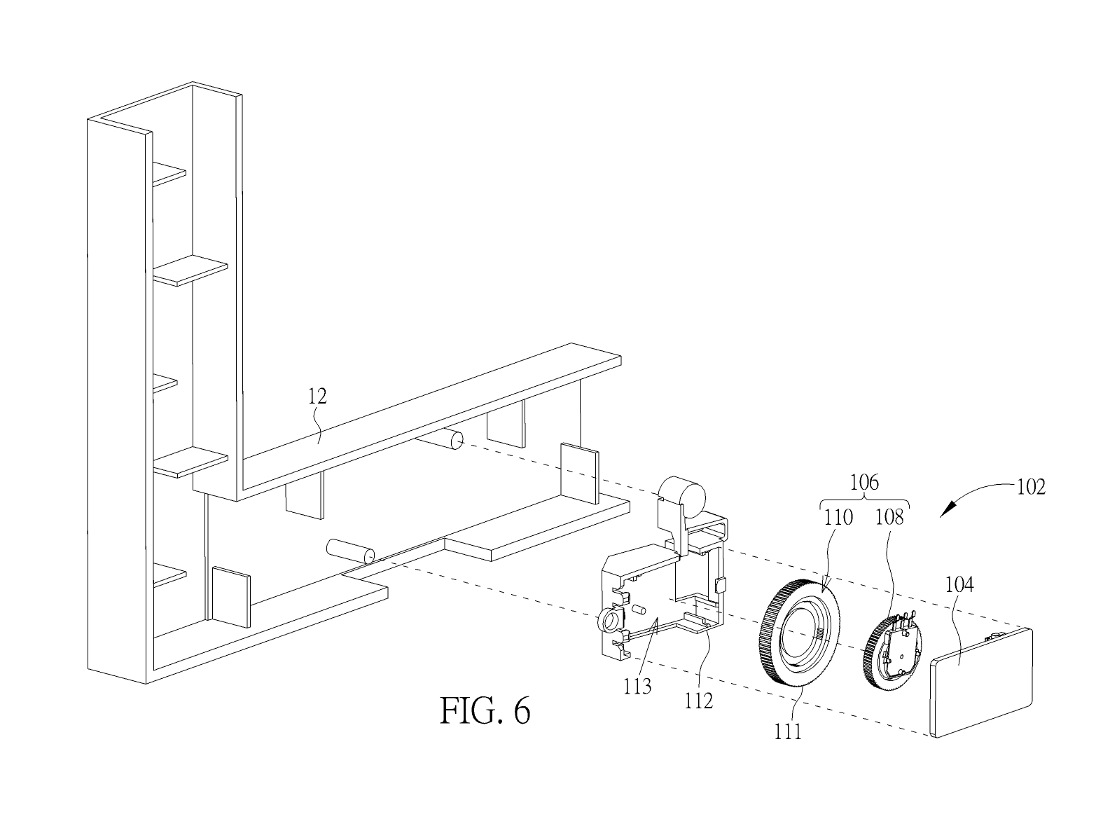

Please refer to FIG. 5, which is a diagram of a display device 100 according to a second embodiment of the present invention. For clearly showing a button module 102, the casing 12 and the device body 14 are depicted partially in FIG. 5. Components both mentioned in the second embodiment and the first embodiment represent components with similar functions or structures, and the related description is omitted herein. As shown in FIG. 5, the display device 100 includes the casing 12, the device body 14, and the button module 102. More detailed description for the button module 102 is provided as follows. Please refer to FIG. 5 and FIG. 6. FIG. 6 is an exploded diagram of the button module 102 and the casing 12 in FIG. 5. The casing 12 is depicted partially in FIG. 6 for clearly showing the structural design of the button module 102. As shown in FIG. 5 and FIG. 6, the button module 102 is disposed in the casing 12 and includes a button circuit board 104 and a triggering member 106. The button circuit board 104 is electrically connected to the device body 14. Accordingly, by triggering the button circuit board 104 (e.g. triggering switches of the button circuit board 104) , the button module 102 could control the device body 14 to execute a corresponding function, such as turning on/off the display device 100 or opening a function menu of the display device 100.

In this embodiment, the triggering member 106 could be a rotatable button, so that the user could rotate the triggering member 106 to trigger the button circuit board 104. To be more specific, in this embodiment, the triggering member 106 could include a button body 108 and a rotatable plate 110. The button body 108 is pivoted to the button circuit board 104. The rotatable plate 110 sleeves the button body 108 and a periphery 111 of the rotatable plate 110 is exposed from the casing 12 (as shown in FIG. 5), so that the user could conveniently rotate the button body 108 via the rotatable plate 110 for triggering the button circuit board 104. To be noted, the rotatable plate 110 could be an omissible component. For example, in another embodiment that a rotatable button is pivoted to the button circuit board 104 and a periphery of the rotatable button is directly exposed from the casing 12, the user could directly rotate the periphery of the rotatable button to make the rotatable button rotate to trigger the button circuit board 104 for controlling the device body 14 to execute a corresponding function.

In practical application, the button module 102 could further include a fixing frame 112. The fixing frame 112 could be fixed on the casing 12 via the structural engagement design aforementioned in the first embodiment, and could have a containing space 113 formed thereon. Accordingly, the containing space 113 could be used for containing the rotatable button (including the button body 108 and the rotatable plate 110) and the button circuit board 104, so as to achieve the purpose that the button body 108, the rotatable plate 110, and the button circuit board 104 could be fixed on the casing 12 steadily via the fixing frame 112.

When the user wants to open a function menu of the display device 100 (i.e. a function corresponding to the mark M as shown in FIG. 5), the user just needs to rotate the periphery 111 of the rotatable plate 110 for making the rotatable button 108 trigger the button circuit board 104. To be noted, the display device 100 could adopt a conventional indication method (e.g. lighting the mark M) for helping the user rotate the rotatable plate 110 to a right position. Accordingly, the device body 14 could be controlled to execute the function corresponding to the mark M (i.e. opening the function menu), so that the user could perform the subsequent operations of the display device 100 (e.g. brightness adjustment of the display device 100). In such a manner, via the aforesaid design that the button circuit board 104 could be triggered by only one triggering member 106, the present invention could efficiently solve the prior art problem that the button manufacturing process is time-consuming and strenuous. Furthermore, since the present invention adopts the structural engagement design aforementioned in the first embodiment to replace a screw locking design for fixing the button circuit board 104 on the casing 12, the present invention could also simplify the button assembly process of the display device 100. As for how to trigger the button circuit board 104 by the button body 108, the present invention could adopt a conventional triggering design (e.g. a point-to-point triggering design), and the related description is omitted herein since it is commonly seen in the prior art.

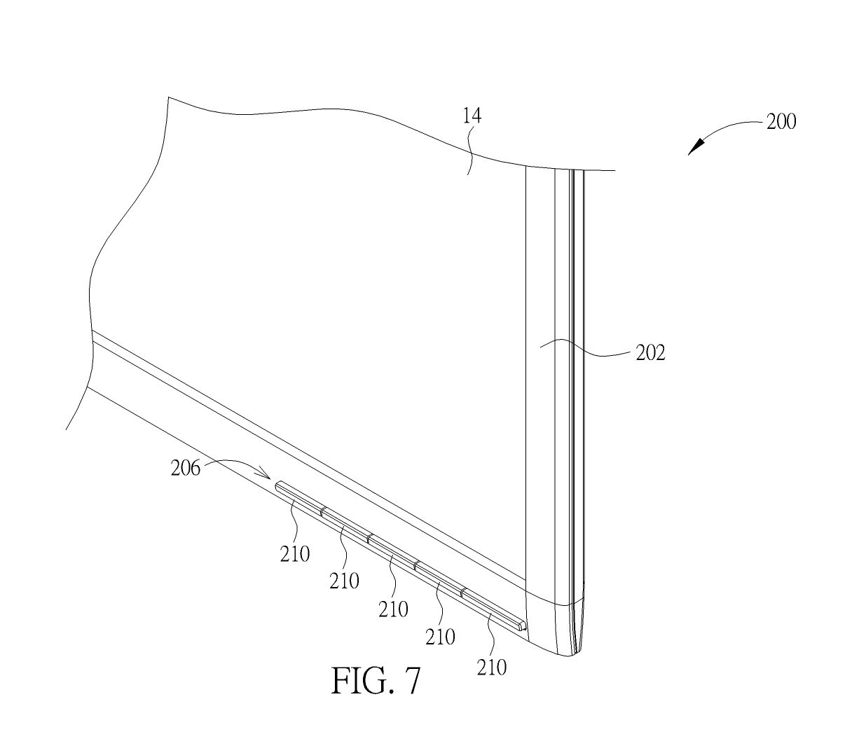

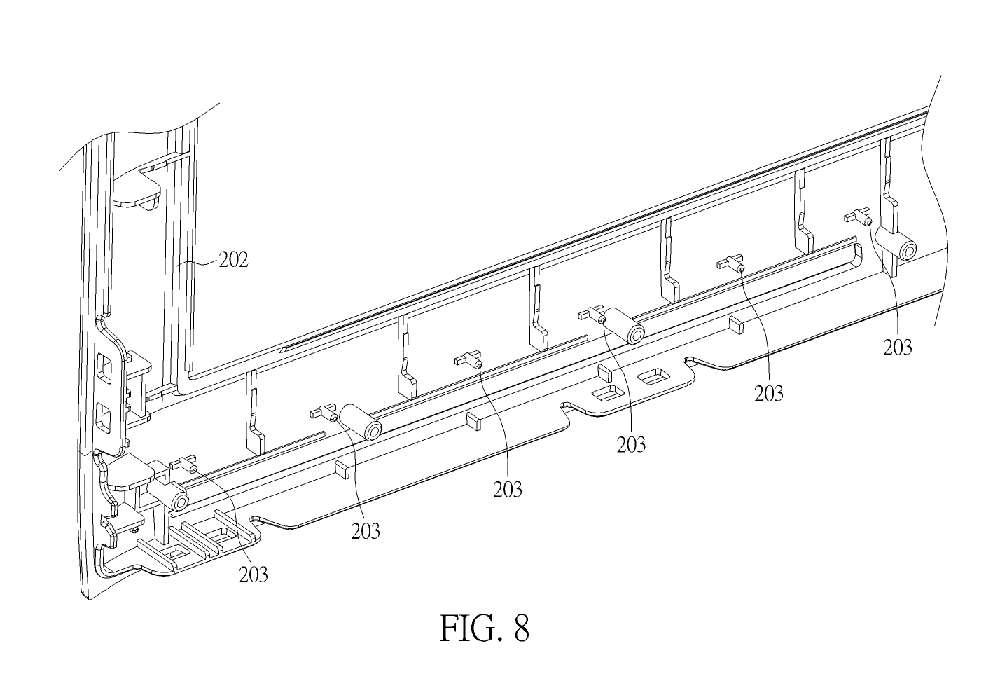

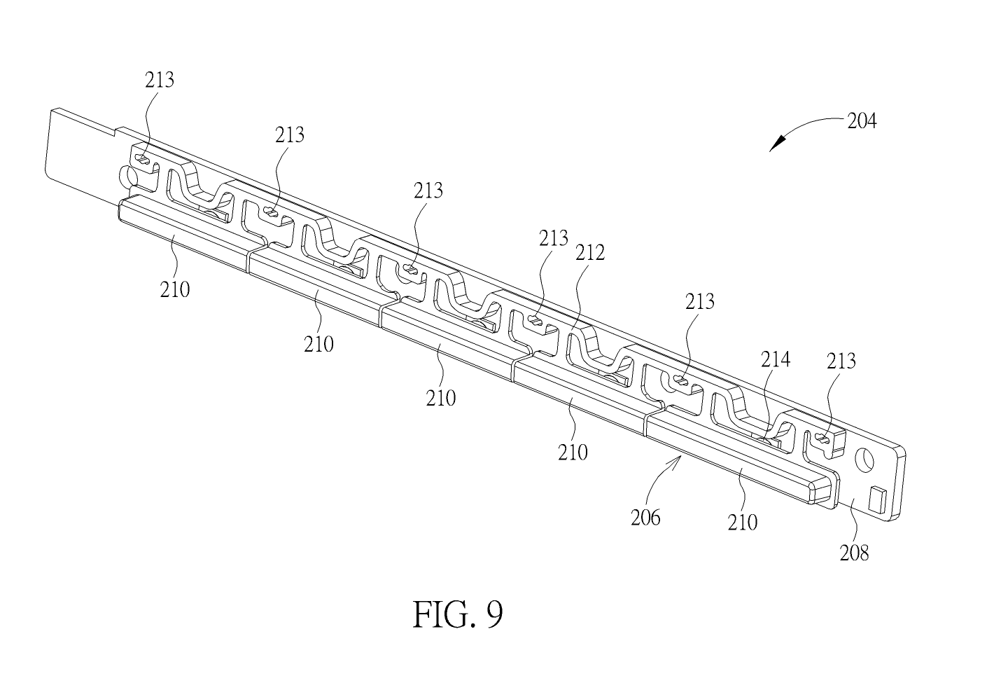

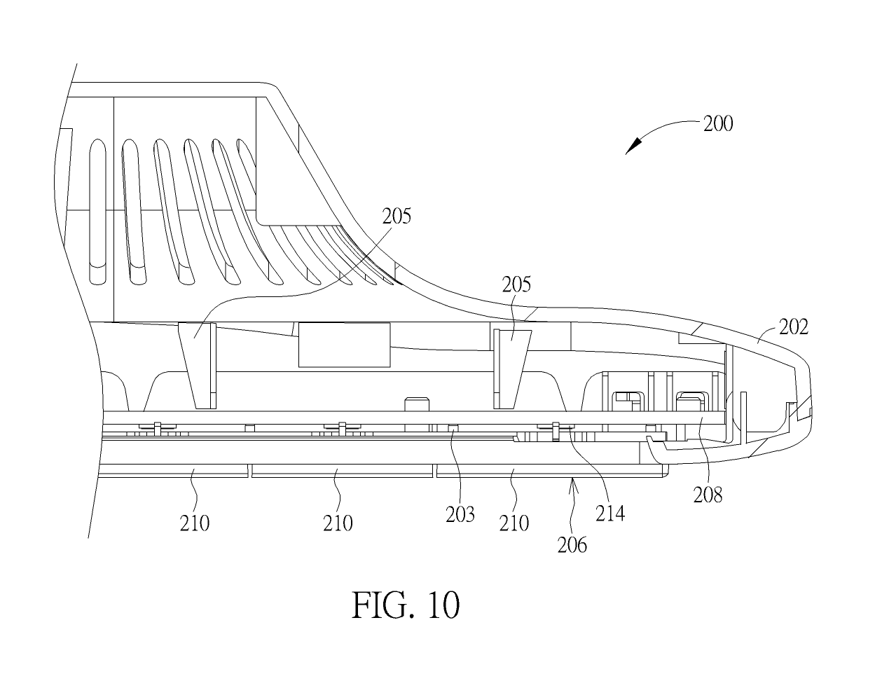

Please refer to FIG. 7, which is a diagram of a display device 200 according to a third embodiment of the present invention. For clearly showing a button module 204, a casing 202 and the device body 14 are depicted partially in FIG. 7. Components both mentioned in the third embodiment and the aforesaid embodiments represent components with similar functions or structures, and the related description is omitted herein. As shown in FIG. 7, the display device 200 includes the casing 202, the device body 14, and the button module 204. More detailed description for the casing 202 and the button module 204 is provided as follows. Please refer to FIG. 7, FIG. 8, FIG. 9, and FIG. 10. FIG. 8 is a partial diagram of the casing 202 in FIG. 7. FIG. 9 is a diagram of the button module 204 in FIG. 7. FIG. 10 is a partial internal diagram of the display device 200 in FIG. 7. As shown in FIG. 7, FIG. 8, FIG. 9, and FIG. 10, the casing 202 has at least one positioning pillar 203 (six shown in FIG. 8, but not limited thereto). The button module 204 includes a button structure 206 and a button circuit board 208. The button structure 206 has a plurality of buttons 210 and a bridge portion 212. The button circuit board 208 is electrically connected to the device body 14 and has a plurality of switches 214. The plurality of buttons 210 extends from the bridge portion 212 corresponding to the plurality of switches 214 and protrudes from the casing 202. The bridge portion 212 has positioning holes 213 corresponding to the positioning pillars 203 respectively. The positioning hole 213 is used for sleeving the corresponding positioning pillar 203 in a tight fitting manner, so as to fix the button structure 208 on the casing 202. Accordingly, the user could press one of the buttons 210 protruding from the casing 202 to trigger the corresponding switch 214 for controlling the device body 14 to execute a corresponding function, such as turning on/off the display device 200 or opening a function menu of the display device 200.

In such a manner, since the present invention adopts the aforesaid structural engagement design to replace a screw locking design for fixing the button structure 206 on the casing 202, the present invention could simplify the button assembly process of the display device 200. Furthermore, as shown in FIG. 10, in this embodiment, the casing 202 could have at least one protruding rib 205 (two shown in FIG. 10, but not limited thereto) formed toward the button circuit board 208 for abutting against a rear side of the button circuit board 208. Accordingly, via the design that the positioning pillar 203 is tightly engaged with the positioning hole 213 of the bridge portion 212 and abuts against a front side of the button circuit board 208 and the protruding rib 205 abuts against the rear side of the button circuit board 208, the button module 204 could be fixed to the casing 202 steadily.

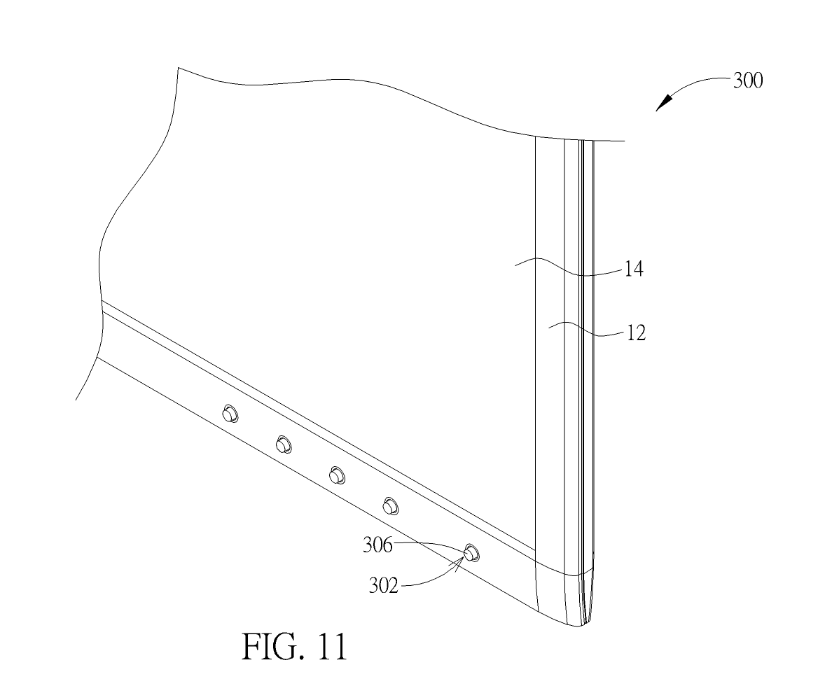

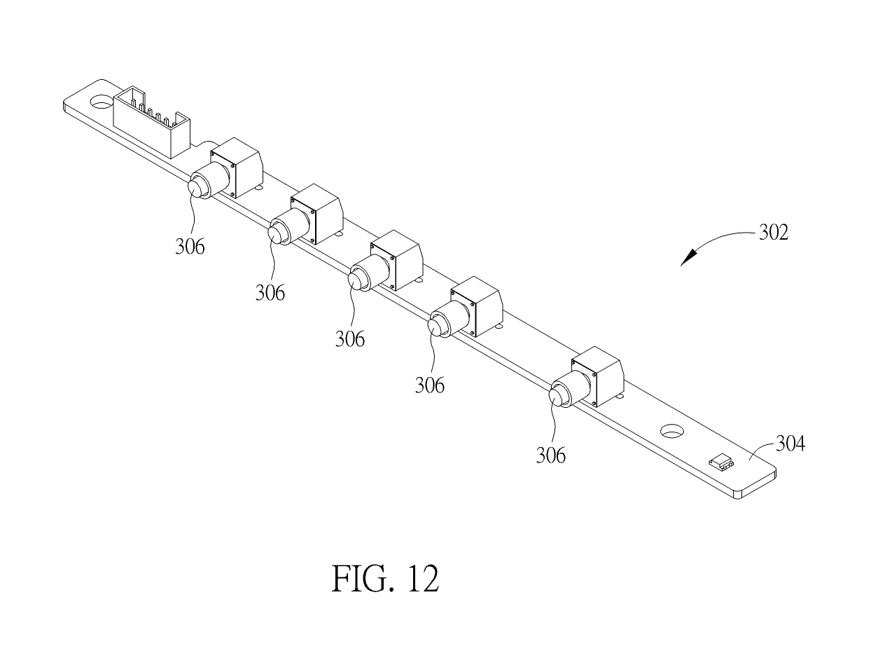

Please refer to FIG. 11, which is a diagram of a display device 300 according to a fourth embodiment of the present invention. For clearly showing a button module 302, the casing 12 and the device body 14 are depicted partially in FIG. 11. Components both mentioned in the fourth embodiment and the aforesaid embodiments represent components with similar functions or structures, and the related description is omitted herein. As shown in FIG. 11, the display device 300 includes the casing 12, the device body 14, and the button module 302. More detailed description for the button module 302 is provided as follows. Please refer to FIG. 11 and FIG. 12. FIG. 12 is a diagram of the button module 302 in FIG. 11. As shown in FIG. 11 and FIG. 12, the button module 302 includes a button circuit board 304 and a plurality of pressing switches 306. The button circuit board 304 is electrically connected to the device body 14. The pressing switches 306 are disposed on the button circuit board 304 and protrude from the casing 12. Accordingly, the user could directly press one of the pressing switches 306 protruding from the casing 12 for controlling the device body 14 to execute a corresponding function, such as turning on/off the display device 300 or opening a function menu of the display device 300.

In such a manner, since disposal of a button structure is omitted in this embodiment, the present invention could simplify the button assembly process of the display device 300. To be noted, the present invention could adopt the structural engagement design aforementioned in the first embodiment for fixing the button circuit board 304 on the casing 12, and the related description is omitted herein since it could be reasoned by analogy according to FIG. 3.

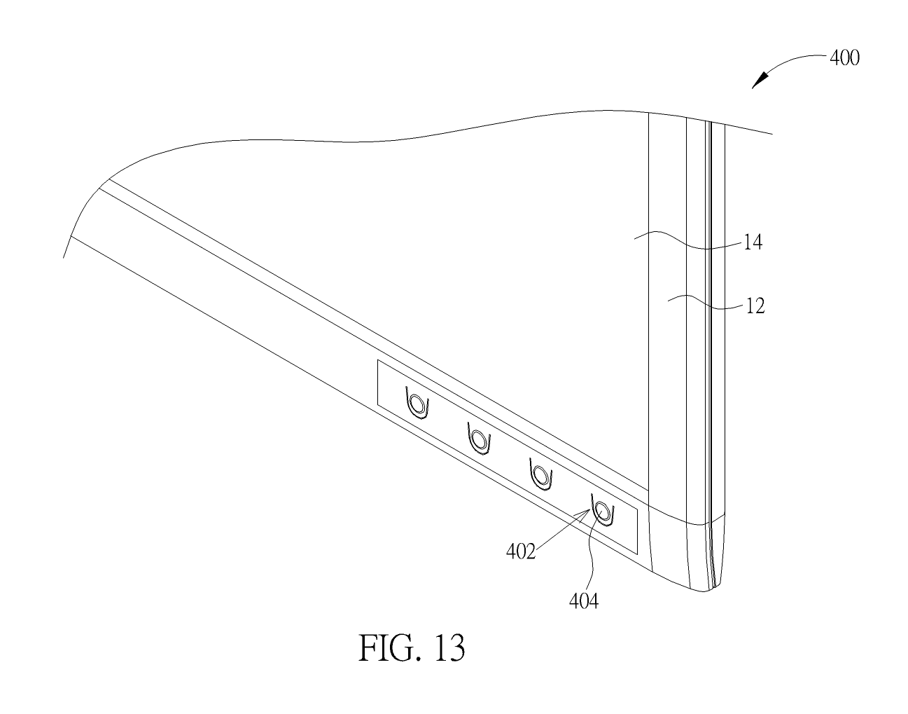

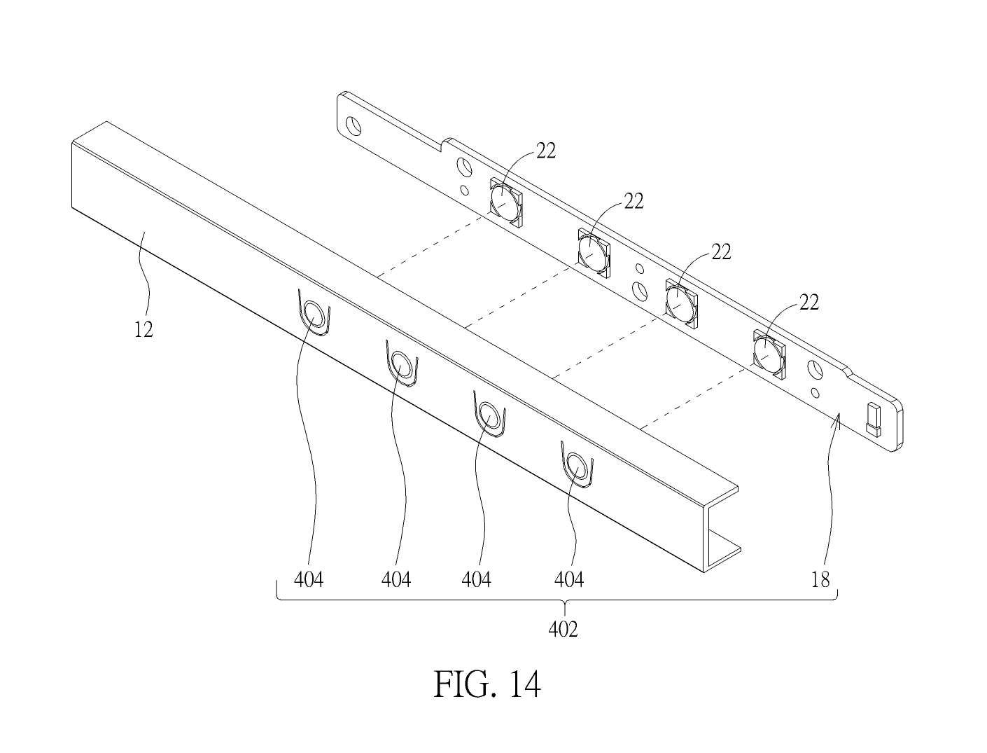

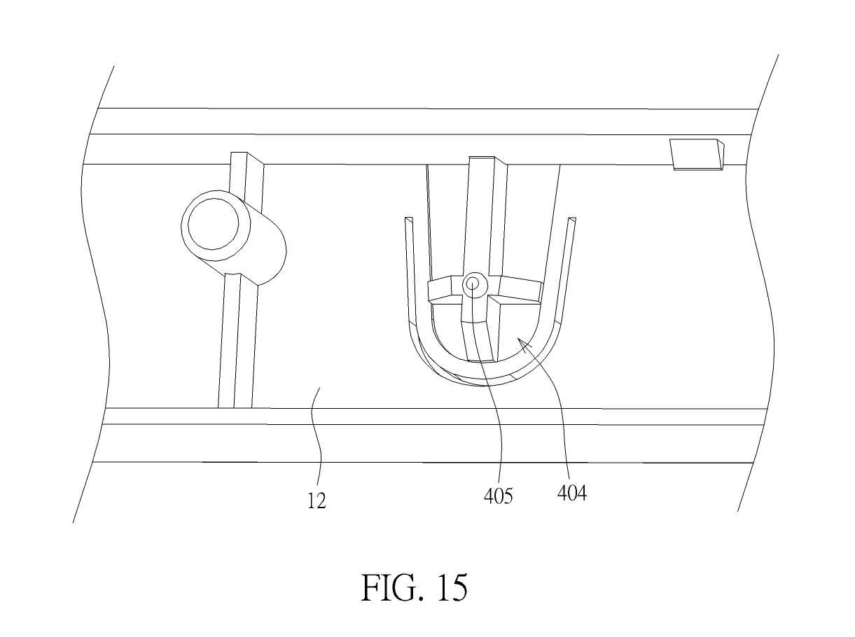

Please refer to FIG. 13, which is a diagram of a display device 400 according to a fifth embodiment of the present invention. For clearly showing a button module 402, the casing 12 and the device body 14 are depicted partially in FIG. 13. Components both mentioned in the fifth embodiment and the aforesaid embodiments represent components with similar functions or structures, and the related description is omitted herein. As shown in FIG. 13, the display device 400 includes the casing 12, the device body 14, and the button module 402. More detailed description for the button module 402 is provided as follows. Please refer to FIG. 13, FIG. 14, and FIG. 15. FIG. 14 is an exploded diagram of the button module 402 in FIG. 13. FIG. 15 is a diagram of a U-shaped button 404 in FIG. 14 at another viewing angle. The casing 12 is depicted partially in FIG. 14 and FIG. 15. As shown in FIG. 13, FIG. 14, and FIG. 15, the button module 402 includes the button circuit board 18 and a plurality of U-shaped buttons 404. The U-shaped button 404 is integrally formed on the casing 12 (e.g. by an injection molding process) and has a protruding structure 405 formed toward the switch 22 on the button circuit board 18. Accordingly, the user could directly press the U-shaped button 404 on the casing 12 to make the protruding structure 405 of the U-shaped button 404 trigger the corresponding switch 22, so as to control the device body 14 to execute a corresponding function, such as turning on/off the display device 400 or opening a function menu of the display device 400. In such a manner, since the U-shaped button 404 is directly formed on the casing 12 in this embodiment, the present invention could simplify the button assembly process of the display device 400.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device comprising:
a casing;
a device body disposed in the casing; and
a button module disposed on the casing, the button module comprising:
a button circuit board electrically connected to the device body; and
a triggering member movably or rotatably disposed at a side of the button circuit board for moving or rotating to trigger the button circuit board so as to control the device body to execute a corresponding function.

2. The display device of claim 1, wherein the button circuit board has a plurality of switches, the triggering member is a sliding button and has a protruding structure formed toward the button circuit board, a sliding slot is formed on the casing, the sliding button is movably inserted into the sliding slot, and the protruding structure is used for pressing one of the switches to control the device body to execute the function corresponding to the one of the switches when the sliding button slides along the sliding slot to make the protruding structure aligned with the one of the switches.

3. The display device of claim 1, wherein the triggering member is a rotatable button, the rotatable button is pivoted to the button circuit board, a periphery of the rotatable button is exposed from the casing, and the rotatable button rotates to trigger the button circuit board for controlling the device body to execute the corresponding function when the periphery of the rotatable button is pushed.

4. The display device of claim 3, wherein the rotatable button comprises a button body and a rotatable plate, the button body is pivoted to the button circuit board, the rotatable plate sleeves the button body, the periphery of the rotatable plate is exposed from the casing, and the button body rotates to trigger the button circuit board with rotation of the rotatable plate for controlling the device body to execute the corresponding function when the periphery of the rotatable plate is pushed.

5. The display device of claim 3, wherein the button module further comprises:
a fixing frame fixed to the casing, a containing space being formed on the fixing frame for containing the rotatable button and the button circuit board to make the rotatable button and the button circuit board fixed to the casing.

6. A button module disposed on a casing of a display device, the button module comprising:
a button circuit board electrically connected to the display device; and
a triggering member movably or rotatably disposed at a side of the button circuit board for moving or rotating to trigger the button circuit board so as to control the display device to execute a corresponding function.

7. The button module of claim 6, wherein the button circuit board has a plurality of switches, the triggering member is a sliding button and has a protruding structure formed toward the button circuit board, a sliding slot is formed on the casing, the sliding button is movably inserted into the sliding slot, and the protruding structure is used for pressing one of the switches to control the device body to execute the function corresponding to the one of the switches when the sliding button slides along the sliding slot to make the protruding structure aligned with the one of the switches.

8. The button module of claim 6, wherein the triggering member is a rotatable button, the rotatable button is pivoted to the button circuit board, a periphery of the rotatable button is exposed from the casing, and the rotatable button rotates to trigger the button circuit board for controlling the device body to execute the corresponding function when the periphery of the rotatable button is pushed.

9. The button module of claim 8, wherein the rotatable button comprises a button body and a rotatable plate, the button body is pivoted to the button circuit board, the rotatable plate sleeves the button body, the periphery of the rotatable plate is exposed from the casing, and the button body rotates to trigger the button circuit board with rotation of the rotatable plate for controlling the device body to execute the corresponding function when the periphery of the rotatable plate is pushed.

10. The button module of claim 8 further comprising:
a fixing frame fixed to the casing, a containing space being formed on the fixing frame for containing the rotatable button and the button circuit board to make the rotatable button and the button circuit board fixed to the casing.
